(19) United States
(12) Patent Application Publication
(10) Pub. No.: US 2013/0077289 A1
(43) Pub. Date: Mar. 28, 2013

(54) Clothing Lighting System

(71) Applicant: Thomas Gridley, Newburyport, MA (US)

(72) Inventor: Thomas Gridley, Newburyport, MA (US)

(73) Assignee: Saucony, Inc., Lexington, MA (US)

(21) Appl. No.: 13/240,130

(22) Filed: Sep. 22, 2011

(51) Int. Cl. F21V 21/08

(52) U.S. Cl. 362/103

(57) ABSTRACT

A lighting system for an article of clothing The lighting system includes illuminable piping disposed on the article of clothing, a light emitter arranged to shine light through the illuminable piping, a power source electrically connected to the light emitter, and a universal serial bus connector electrically connected to the power source for charging the power source.

### TECHNICAL FIELD

This disclosure relates to lighting systems for articles of clothing

### BACKGROUND

Outdoor enthusiasts and workers may be exercising or working outside in early dawn hours or late evening hours. At these times of day, the lighting generally makes it relatively more difficult for observers to see the person exercising or working. Generally, light colored clothing provides observers with a greater likelihood of seeing the person wearing the light colored clothing Moreover, articles of clothing including illuminated lights generally provide visibility of the wearer as well.

### SUMMARY

One aspect of the disclosure provides a lighting system for an article of clothing The lighting system includes illuminable piping disposed on the article of clothing, a light emitter arranged to shine light through the illuminable piping, a power source electrically connected to the light emitter, and a universal serial bus connector electrically connected to the power source for charging the power source.

Implementations of the disclosure may include one or more of the following features. In some implementations, the lighting system includes a control circuit controlling delivery of an electric current from the power source to the light emitter. The control circuit may provide at least one of constant and intermittent delivery of current from the power source to the light emitter. The power source may comprise at least one of a battery and a capacitor.

In some examples, the light emitter (e.g., a light emitting diode (LED)) is disposed remotely from the power source. For example, the light emitter can be connected to the illuminable piping disposed on one portion of the article clothing, such as a rear surface, while the power source is disposed on another portion of the article of clothing, such as in a pocket of a front surface of the article of clothing

The power source may have the capacity to power the light emitter for about 100,000 hours. Moreover, a 20 minute charge of the power source may provide power for about one hour of continuous light emission from the light emitter.

In some examples, the illuminable piping comprises fiber optic piping that includes a tubular body that can be attached (e.g., sewn, glued, etc.) to the article of clothing In other examples, the fiber optic piping includes a tubular body and a flange disposed along the tubular body for attaching the fiber optic piping to the article of clothing Moreover, in some examples the illuminable piping comprises electroluminescent piping.

Another aspect of the disclosure provides a lighting system for an article of clothing that includes a first illuminable piping disposed a front surface on the article of clothing, a second illuminable piping disposed a rear surface on the article of clothing, and a power unit housing a power source in electrical communication with a universal serial bus connector for charging the power source. The power unit is electrically connected to a light emitter of each the first illuminable piping and the second illuminable piping.

In some implementations, the power unit includes a control circuit controlling delivery of an electric current from the power source to the light emitter. The control circuit may provide at least one of constant and intermittent delivery of the electric current from the power source to the light emitter. In some examples, the power source comprises at least one of a battery and a capacitor. The power source may have the capacity to power the light emitter for about 100,000 hours. Moreover, a 20 minute charge of the power source may provide power for about one hour of continuous light emission from each light emitter.

Each light emitter may be disposed remotely from the power source. At least one light emitter may comprise a light emitting diode. In some examples, the illuminable piping comprises a tubular body and a flange disposed along the tubular body for attaching the illuminable piping to the article of clothing One end of the tubular body may be configured to receive the light emitter arranged to shine light through the tubular body. In additional examples, the illuminable piping comprises electroluminescent piping.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1A is a front view of an exemplary article of clothing having a lighting system.

FIG. 1B is a rear view of the article of clothing shown in FIG. 1A.

FIG. 1C is a front view of an exemplary article of clothing having a lighting system.

FIG. 1D is a rear view of the article of clothing shown in FIG. 1C.

FIG. 1E is a front view of an exemplary article of clothing having a lighting system.

FIG. 1F is a rear view of the article of clothing shown in FIG. 1E.

FIG. 2 is a perspective view of exemplary fiber optic piping.

FIG. 3A is a top view of an exemplary light source.

FIG. 3B is a schematic view of an exemplary light source having a universal serial bus connector for establishing an electrical connection with an electronic device.

FIG. 3C is a schematic view of an exemplary light source having clip.

FIG. 4 is a side view of an exemplary light emitter attached to fiber optic piping.

FIG. 5 is a top view of an exemplary light source having a light emitter disposed remotely from a power source.

FIG. 6 is a top view of an exemplary power unit disposed remotely from electroluminescent piping.

Like reference symbols in the various drawings indicate like elements.

### DETAILED DESCRIPTION

People working or exercising outside may wear a highly visible garment or clothing item that assists others in seeing the garment wearer. A runner may wear the highly visible garment to allow drivers of passing vehicles to more readily recognize and see the runner (e.g., so as to steer clear of the runner).

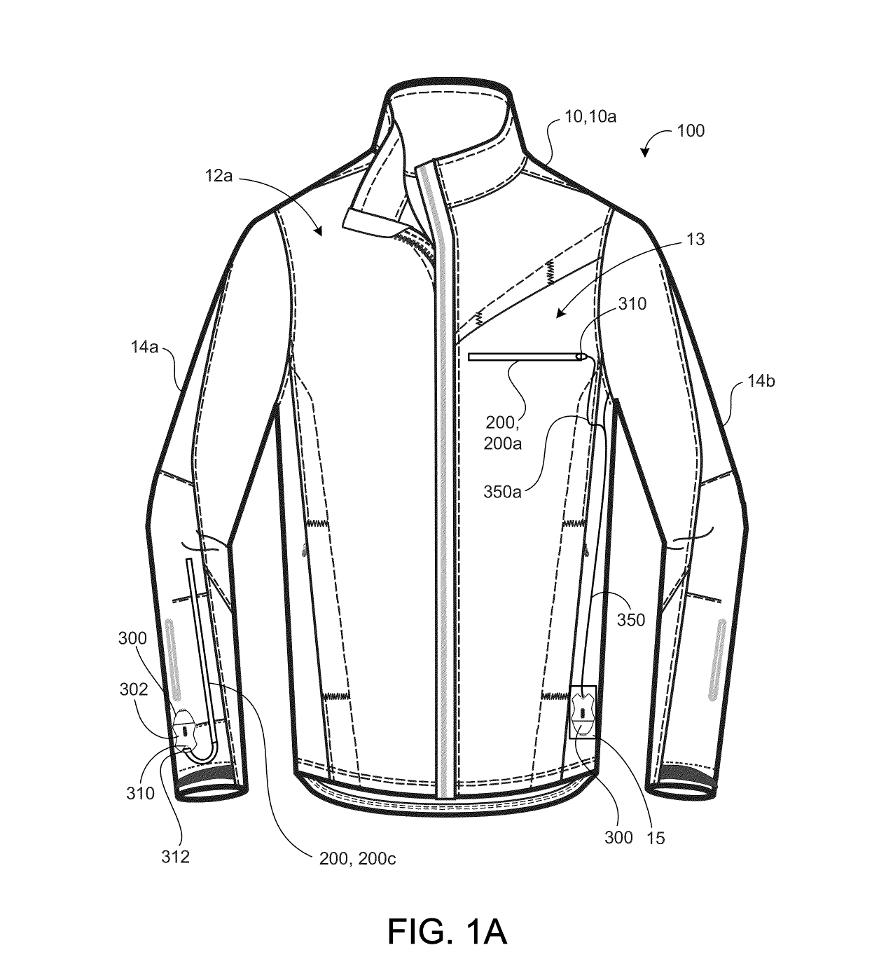

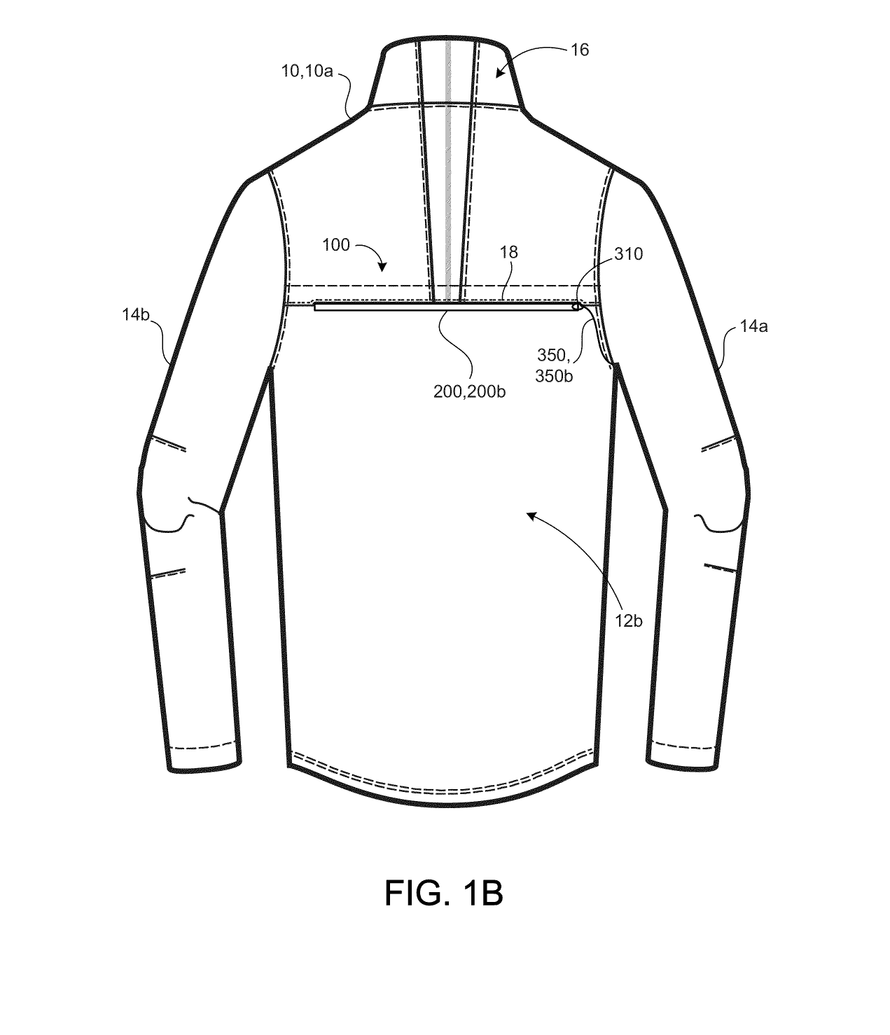

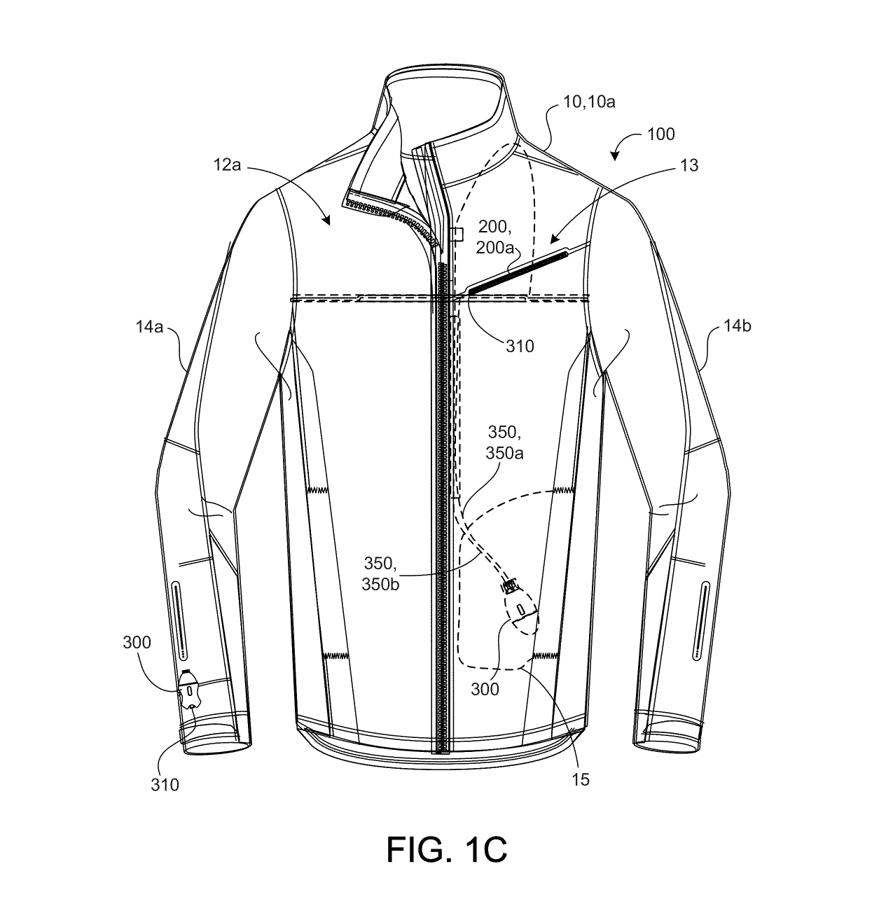

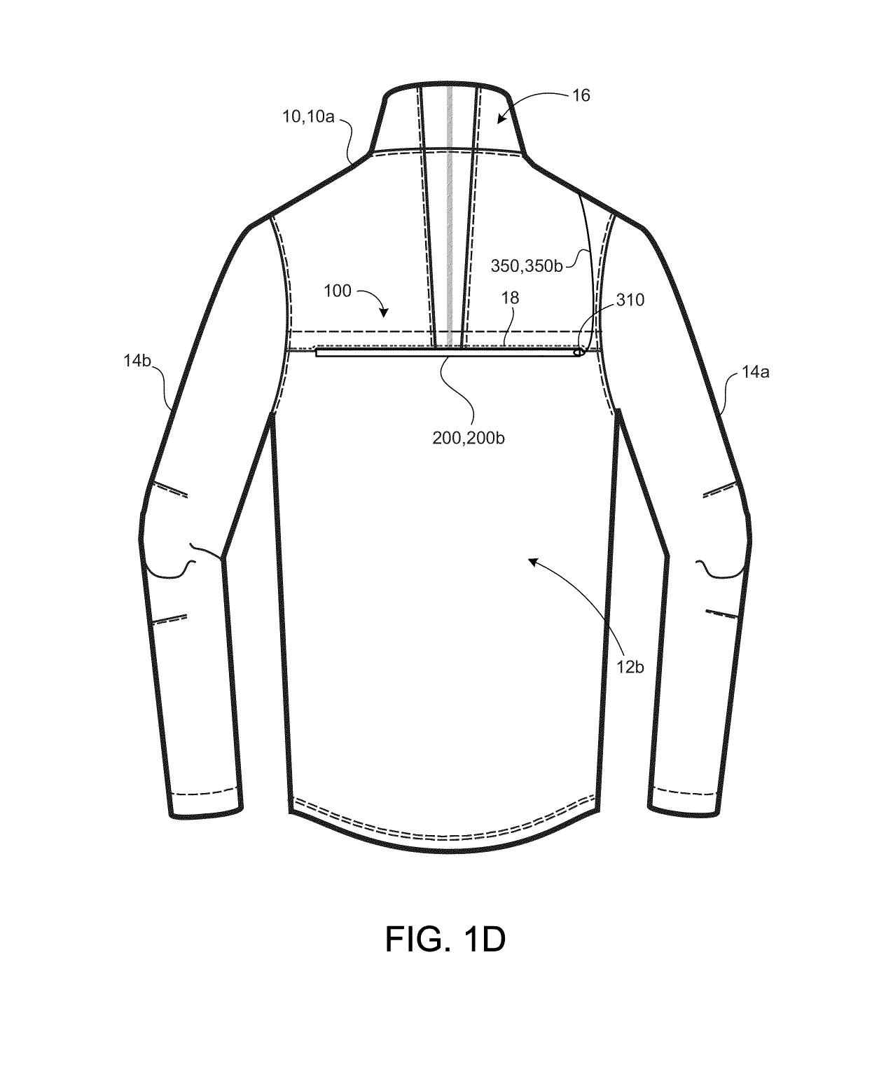

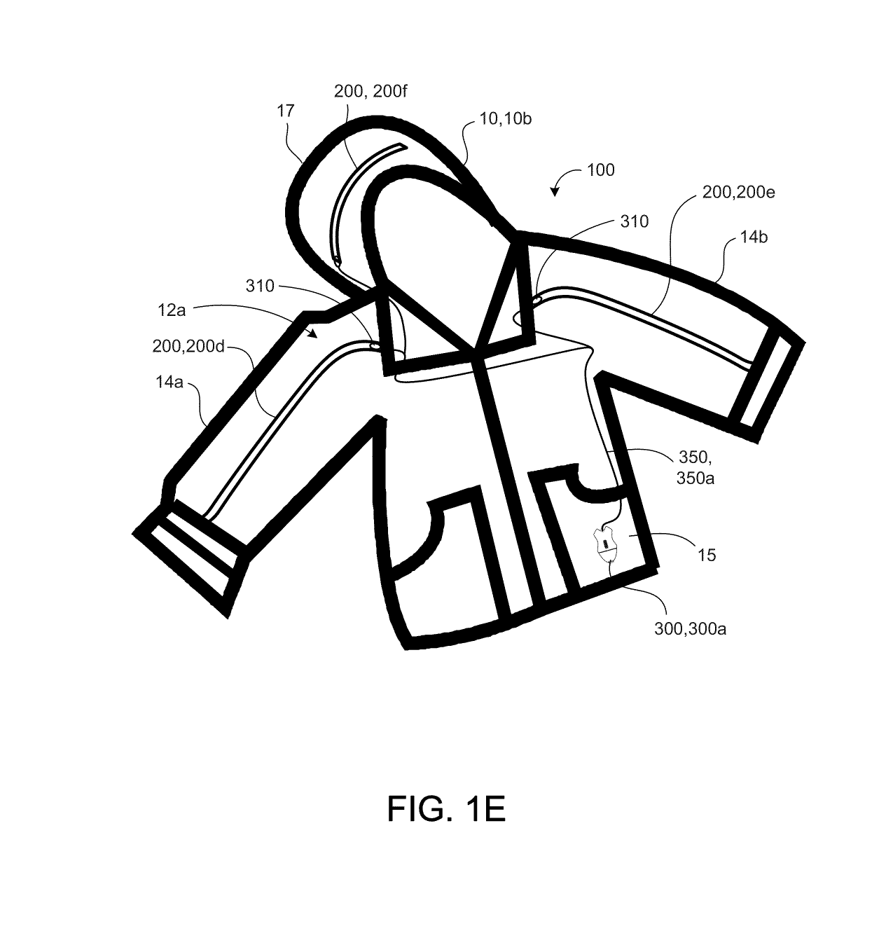

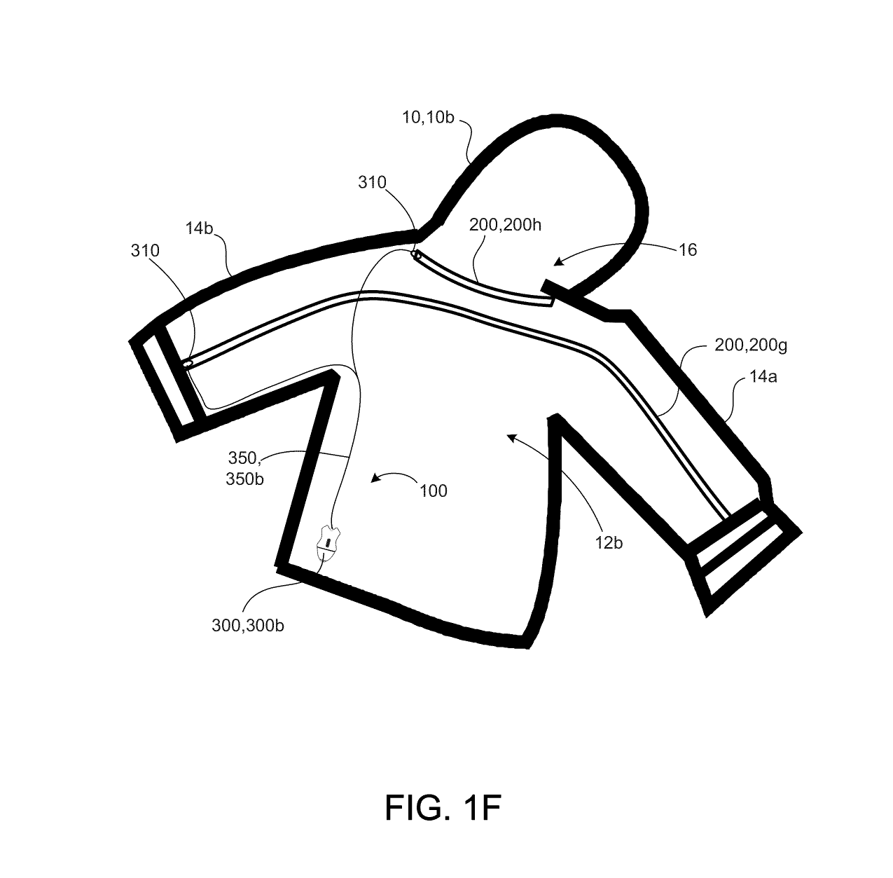

Referring to FIGS. 1A-1D, a lighting system 100 for an article of clothing 10 (e.g., shirt, jacket, shoe, hat, etc.) includes at least one illuminable piping 200 disposed on the article of clothing 10 and a light source 300 having a light emitter 310 arranged to emit light into the illuminable piping 200. The illuminable piping 200 may be fiber optic piping (e.g., extruded Polyurethane (PU) tubing), electroluminescent piping, an assembly of lights (e.g., light emitting diodes), or other lighting device. The illuminable piping 200 can be arranged in any manner on the article of clothing 10. For example, to provide visibility of a person at night, the lighting system 100 may include illuminable piping 200 disposed across a front surface 12a and/or rear surface 12b of the article of clothing 10 (e.g., a jacket 10a).

In the example shown in FIG. 1A, the lighting system 100 includes a first illuminable piping 200a disposed substantially horizontally across a chest area 13 of the article of clothing 10. In the example shown in FIG. 1C, the lighting system 100 includes the first illuminable piping 200a disposed substantially vertically or diagonally across the chest area 13 of the article of clothing 10. In FIGS. 1B and 1D, the lighting system 100 includes a second illuminable piping 200b disposed substantially horizontally across the rear surface 12b of the article of clothing 10. Although the second illuminable piping 200b is shown disposed substantially horizontally, it may be disposed in any other orientation as well (e.g., vertically, diagonally, arcuately, etc.).

Other exemplary placements include, but are not limited to, along a top, bottom, front, rear, and/or side surfaces of the article of clothing 10. For example, on a jacket 10a, the illuminable piping 200, 200c can be arranged to run along right and/or left sleeves 14a, 14b of the jacket 10a and/or around a collar portion 16 of the jacket 10a. Other placements and arrangements are possible as well, for example, circular, arcuate, and polygonal arrangements. FIGS. 1E and 1F illustrate other exemplary placements and arrangements of the of the lighting system 100 on a hooded jacket 10b. The lighting system 100 includes first and second illuminable piping 200d, 200e arranged to run along right and left sleeves 14a, 14b of the jacket 10b, a third illuminable piping 200f about a hood 17, a fourth illuminable piping 200g along a rear surface 12b, and a fifth illuminable piping 200h around a collar portion 16 of the jacket 10b. A first wire harness 350a delivers power between the power source 330 the first, second, and third illuminable piping 200d-f (e.g., to respective light emitters 310) on the front surface 12a and hood 17. A second wire harness 350b delivers power between the power source 330 and the fourth and fifth illuminable piping 200g-h (e.g., to respective light emitters 310) on the rear surface 12b. Moreover, the lighting system 100 may include multiple light sources 300. For example, a first light source 300a may service the illuminable piping 200 on the front surface 12a of the clothing article 10 and a second light source 300b may service the illuminable piping 200 on the front surface 12b of the clothing article 10.

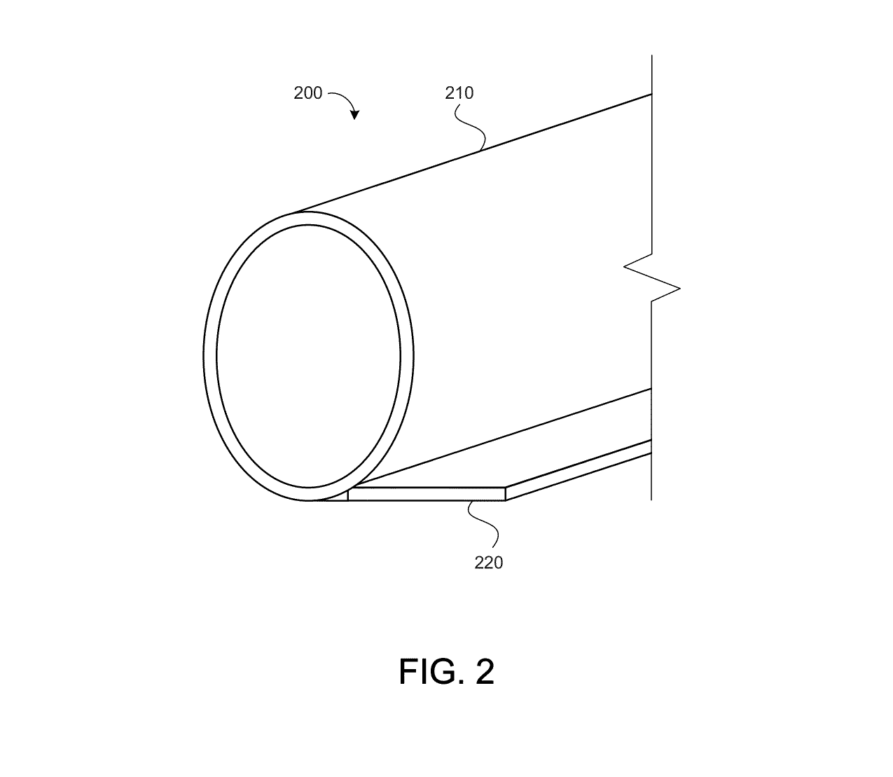

Referring to FIG. 2, in some implementations, the illuminable piping 200 comprises fiber optic tubing defining a tubular shape having a hollow cross-section (e.g., circular, polygonal, etc.). The illuminable piping 200 may be attached (e.g., sewn, glued, etc.) directly to the article of clothing 10. In some examples, the illuminable piping consists of a tubular body 210 that can be attached (e.g., sewn, glued, etc.) to the article of clothing 10. In other examples, such as the example shown in FIG. 2, the illuminable piping 200 includes a tubular body 210 for receiving light therethrough and a flange 220 disposed on the tubular body 210 for attaching the illuminable piping 200 to the article of clothing 10. For example, the flange 220 can be attached to the article of clothing 10 and arranged so that the tubular body 210 is exposed exteriorly on the article of clothing 10, while the flange 220 is relatively hidden in a seam 18 (FIG. 1B) of the article of clothing 10.

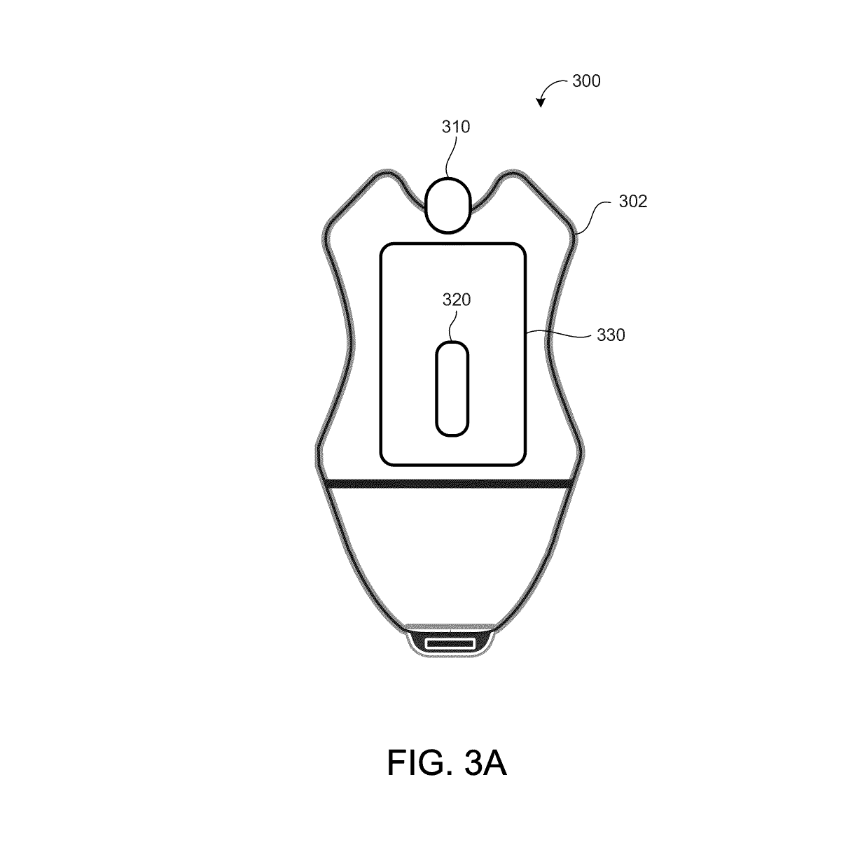

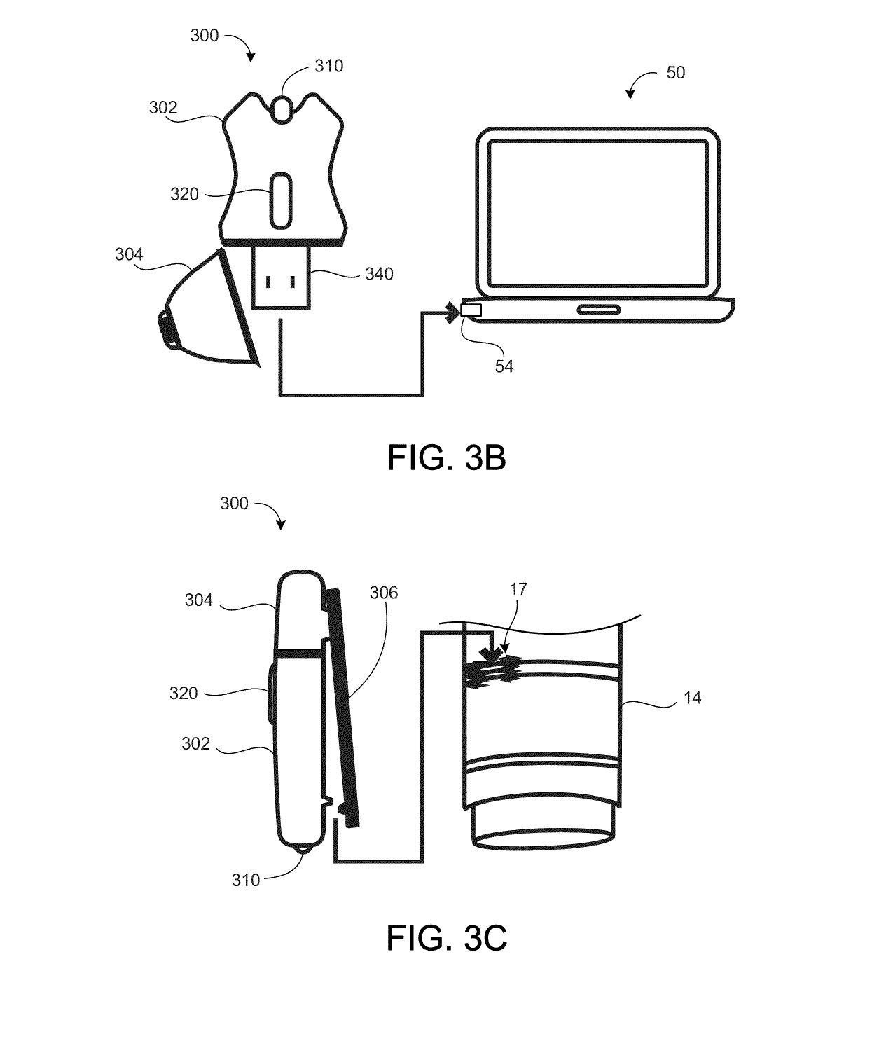

Referring to FIG. 3A, in some implementations, the light source 300 includes a light emitter 310 (e.g., light emitting diode (LED)) in electrical communication with a control circuit 320 (e.g., a toggle switch, a printed circuit board, etc.) and a power source 330. The control circuit 320 controls delivery of an electric current from the power source 330 to the light emitter 310. In some examples, the control circuit 320 provides at least one of constant and intermittent delivery of current from the power source 330 to the light emitter 310. For example, a user may set the control circuit 320 (via a button, switch, dial, etc.) to cause the light emitter 310 to blink at a set or user-defined rate, or provide constant illumination.

The light emitter 310 may provide light visible up to about 100 yards away. In the example shown, the light source 300 includes a housing 302 configured to support the light emitter 310, the control circuit 320, and the power source 330 (e.g., as a compact unit). The housing 302 can be made of plastic or any other suitable material. The power source 330 may be a battery (e.g., lithium ion, silver-zinc, etc.) and/or a capacitor. The power source 330 may have the capacity to power the light emitter 310 for about 100,000 hours. In some examples, a 20 minute charge of the power source 330 provides power for about one hour of continuous light emission from the light emitter 310. Therefore, a one hour charge may provide about 3 hours of continuous light emission by the light source 300.

In the example shown in FIG. 3B, the light source 300 includes a universal serial bus (USB) connector 340 in electrical communication with the power source 330. The USB connector 340 can be received by an electronic device 50 having a mating USB connector 54 capable of providing power, such as on a computing device (e.g., laptop, touch pad, desktop computer, etc.). This allows a user to charge the power source 330 using another portable device, rather than having to connect the light source 300 to a standard electrical outlet. In some examples, an adaptor having a mating USB connector and a transformer can be used to interface between a standard electrical outlet and the light source 300.

In the example shown in FIG. 3C, the light source 300 includes a cap 304 received over the USB connector 340. The cap 304 may have an interference fit, snap fit, or other means of connection with the housing 302. Moreover, the cap 304 may include a clip 306 for securing the light source 300 to the article of clothing 10. In the example shown, the light source 300 is received into and clips onto a pocket 17 of a sleeve 14 of the article of clothing 10. A similar example is shown in FIG. 1C, which depicts a light source 300 attached to the right sleeve 14a of the jacket 10a.

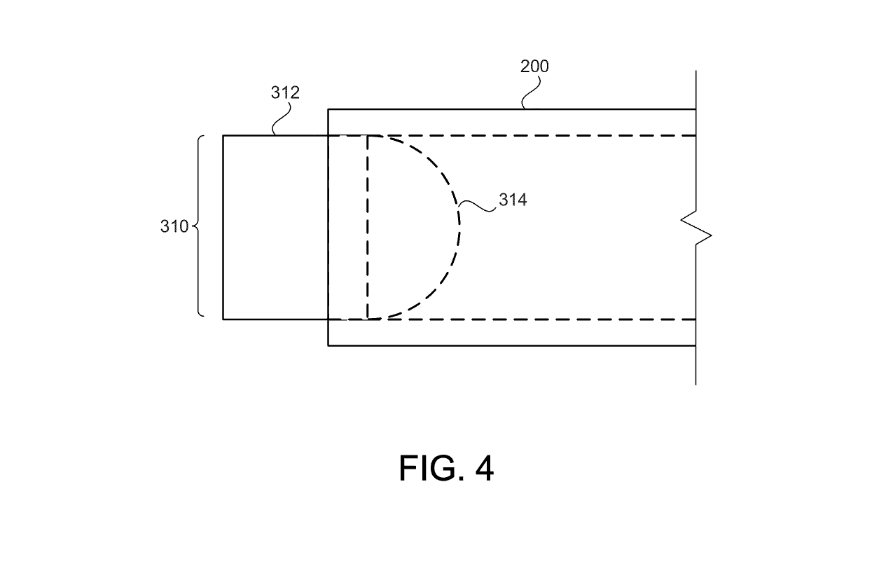

Referring again to FIGS. 1A-1D and 4, in some implementations, the light emitter 310 and/or the housing 302 is configured to releasably receive or connect directly to the illuminable piping 200. In the examples shown, the light emitter 310 extends into the tubular illuminable piping 200, so that emitted light travels through the tubular illuminable piping 200. The light emitter 310 may have a connector portion 312 and a lens portion 314 The connector portion 312 can be configured to connect (fixedly or releasably) to the illuminable piping 200, while holding the lens portion 314 inside the illuminable piping 200. For example, the connector portion 312 may have an interference fit and/or snap fit into or onto the illuminable piping 200. In the example shown in FIG. 1A, the lighting system 100 includes a light source 300 have a connector portion 312 disposed on the housing 302 for direct connection of the illuminable piping 200, 200c to the housing 302. The light system 100 may also include a light source having the housing 302 disposed remotely from the connector portion 312 and light emitter 310.

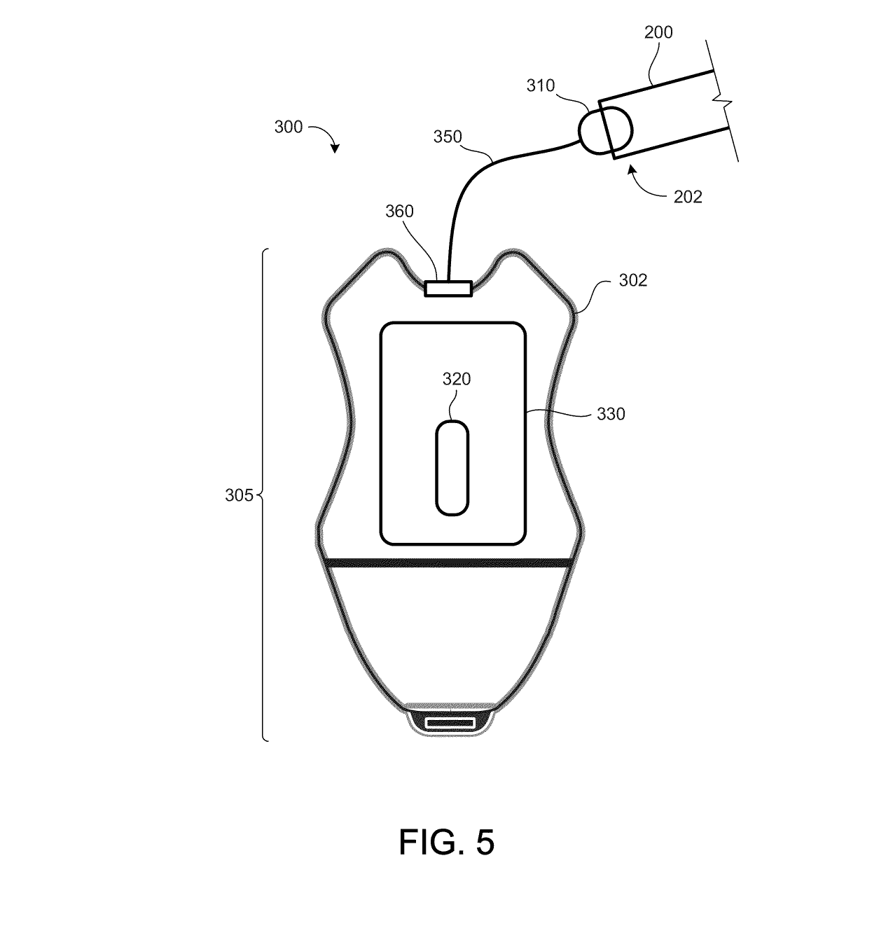

With additional reference to FIG. 5, in some implementations, the housing 302 supports the control circuit 320, the USB connector 340, and the power source 400, as a power unit 305; however, the light emitter 310 is disposed remotely from the housing 302, while remaining in electrical communication with the control circuit 320 and the power source 400 via a wire 350. The light source 300 may include an electrical connector 360 for releasably connecting the wire 350 to the housing 302 for establishing an electrical connection with the control circuit 320 and the power source 400. This configuration allows the control circuit 320 and the power source 400 to be disposed in a first location separate from a second location of the light emitter 310, which can be connected to an end 202 of the illuminable piping 200.

The illuminable piping 200 may terminate anywhere on the jacket 10a. The light emitter 310 can be releasable or fixedly attached to the end 202 of the illuminable piping 200 for shining light therethrough. In the example shown in FIG. 1A, a first light source 300a includes a first wire 350a extending from the housing 302 to a light emitter 310 connected to the first illuminable piping 200a and second wire 350b extending from the housing 302 to a light emitter 310 connected to the second illuminable piping 200a. The housing 302 can be placed in a convenient location, such as in a pocket 15 of the jacket 10a.

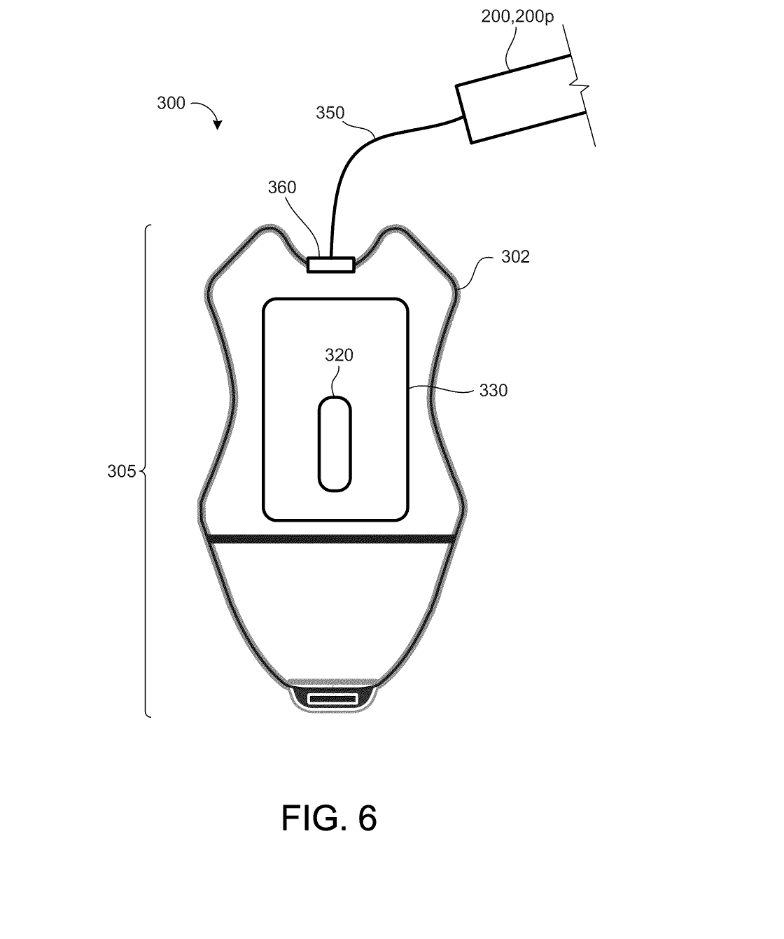

In each of the examples discussed, the illuminable piping 200 can be an electroluminescent strip or piping disposed in electrical communication with the power unit 305. In this configuration, the light source 300 does not include the light emitter 310, but rather has the power source 330 housed in the power unit 305 electrically coupled (e.g., via the wire(s) 350 and/or the control circuit 320) to the electroluminescent illuminable piping 200, 200p, for example, as shown in FIG. 6. Moreover, in some implementations, the lighting system 100 may include both fiber optic illuminable piping 200 and electroluminescent illuminable piping 200 both connected (e.g., via the wire(s) 350 and/or the control circuit 320) to the power source 330.

A number of implementations have been described. Nevertheless, it will be understood that various modifications may be made without departing from the spirit and scope of the disclosure. Accordingly, other implementations are within the scope of the following claims.

What is claimed is:

1. A lighting system for an article of clothing, the lighting system comprising:
illuminable piping disposed on the article of clothing;
a light emitter arranged to illuminate the illuminable piping;
a power source electrically connected to the light emitter; and
a universal serial bus connector electrically connected to the power source for charging the power source.

2. The lighting system of claim 1, further comprising a control circuit controlling delivery of an electric current from the power source to the light emitter.

3. The lighting system of claim 2, wherein the control circuit provides at least one of constant and intermittent delivery of current from the power source to the light emitter.

4. The lighting system of claim 1, wherein the power source comprises at least one of a battery and a capacitor.

5. The lighting system of claim 1, wherein the light emitter is disposed remotely from the power source.

6. The lighting system of claim 1, wherein the light emitter comprises a light emitting diode.

7. The lighting system of claim 1, wherein the power source has the capacity to power the light emitter for about 100,000 hours.

8. The lighting system of claim 1, wherein a 20 minute charge of the power source provides power for about one hour of continuous light emission from the light emitter.

9. The lighting system of claim 1, wherein the illuminable piping comprises a tubular body and a flange disposed along the tubular body for attaching the illuminable piping to the article of clothing

10. The lighting system of claim 1, wherein the illuminable piping comprises electroluminescent piping.

11. A lighting system for an article of clothing, the lighting system comprising:
a first illuminable piping disposed a front surface on the article of clothing;
a second illuminable piping disposed a rear surface on the article of clothing; and
a power unit housing a power source in electrical communication with a universal serial bus connector for charging the power source, the power unit electrically connected to a light emitter of each the first illuminable piping and the second illuminable piping.

12. The lighting system of claim 11, wherein the power unit comprises a control circuit controlling delivery of an electric current from the power source to the light emitter.

13. The lighting system of claim 12, wherein the control circuit provides at least one of constant and intermittent delivery of the electric current from the power source to the light emitter.

14. The lighting system of claim 11, wherein the power source comprises at least one of a battery and a capacitor.

15. The lighting system of claim 11, wherein each light emitter is disposed remotely from the power source.

16. The lighting system of claim 11, wherein at least one light emitter comprises a light emitting diode.

17. The lighting system of claim 11, wherein the power source has the capacity to power the light emitter for about 100,000 hours.

18. The lighting system of claim 11, wherein a 20 minute charge of the power source provides power for about one hour of continuous light emission from each light emitter.

19. The lighting system of claim 11, wherein the illuminable piping comprises a tubular body and a flange disposed along the tubular body for attaching the illuminable piping to the article of clothing, one end of the tubular body configured to receive the light emitter arranged to shine light through the tubular body.

20. The lighting system of claim 12, wherein the illuminable piping comprises electroluminescent piping.
